(19) United States
(12) Patent Application Publication
(10) Pub. No.: US 2009/0235072 A1
(43) Pub. Date: Sep. 17, 2009

(54) SYSTEM, TERMINAL, METHOD, AND SOFTWARE FOR COMMUNICATING MESSAGES

(75) Inventors: Declan Patrick Kelly, Shanghai (CN); Claudine Viegas Conrado, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,054

(22) PCT Filed: Dec. 7, 2005
(86) PCT No.: PCT/IB05/54102

§ 371 Date: Jun. 7, 2007

(30) Foreign Application Priority Data
Dec. 14, 2004 (EP) 04106538.4

(51) Int. Cl. H04L 9/32

(52) U.S. Cl. 713/168; 726/3

(57) ABSTRACT

A system for secure communication of a message from a first terminal to a second terminal being operatively coupled by means of a communication network comprising an authenticating station for obtaining a random seed and for obtaining a masked seed by applying a masking function to the seed by encrypting the message using the masked seed for transmitting the seed and the encrypted message to the authenticating station; the authenticating station comprising further means for obtaining a further random seed for receiving the seed and the encrypted message for recovering the further masked seed by applying the masking function to the seed by decrypting the encrypted message using the recovered masked seed and by applying a masking function to the further seed by encrypting the recovered message using the further masked seed for transmitting the further seed and the further encrypted message to the second terminal; the second terminal comprising receiving means for receiving the further seed and the further encrypted message for recovering the further masked seed by applying the masking function to the further seed by decrypting the further encrypted message using the recovered further masked seed.

The invention relates to a system for secure communication of a message from a first terminal to a second terminal, the first terminal being operatively coupled to the second terminal by means of a communication network comprising an authenticating station.

The invention also relates to a first terminal, a second terminal, an authenticating station, a method and computer program products for use in such a system.

The problem of securely communicating a message between two parties is well known. It requires keeping the message secret while it is being communicated as well as authentication of the sending party and the receiving party. Secrecy and authentication may be provided to a certain extent by a telephony system. Someone answering a call as expected authenticates the other party.

In a mobile phone network, for example, in accordance with the GSM standard, ciphered telephone conversations are held between the mobile phone and the base station, as described in specification 3GPP TS 43.020 V5.0.0, section 4.3. This secures the telephone conversation against eavesdropping on the air interface only.

It is a drawback of this known system that it does not provide highly secure end-to-end communication between the first and the second terminal.

It is an object of the invention to provide a system of the type described in the opening paragraph, wherein the message may be securely communicated end-to-end, approaching the level of security of the subscription to the network.

The object is realized in the system comprising:

the first terminal, comprising:
means for obtaining a random seed (S_{A}),
computing means for obtaining a masked seed (M_{A}) by applying a masking function (F_{A}) to the seed (S_{A}), and for obtaining an encrypted message (K_{A}) by encrypting the message (M) using the masked seed (M_{A}),
transmitting means for transmitting the seed (S_{A}) and the encrypted message (K_{A}) to the authenticating station;

the authenticating station, comprising:
further means for obtaining a further random seed (S_{B}),
receiving means for receiving the seed (S_{A}) and the encrypted message (K_{A});
further computing means for:

a. recovering the masked seed (M_{A}) by applying the masking function (F_{A}) to the seed (S_{A}),

b. recovering the message (M) by decrypting the encrypted message (K_{A}) using the recovered masked seed (M_{A}),

c. obtaining a further masked seed (M_{B}) by applying a masking function (F_{B}) to the further seed (S_{B}), and

d. obtaining a further encrypted message (K_{B}) by encrypting the recovered message (M) using the further masked seed (M_{B}),
further transmitting means for transmitting the further seed (S_{B}) and the further encrypted message (K_{B}) to the second terminal;

the second terminal, comprising:
receiving means for receiving the further seed (S_{B}) and the further encrypted message (K_{B});
still further computing means for:

a. recovering the further masked seed (M_{B}) by applying the masking function (F_{B}) to the further seed (S_{B}),
recovering the message (M) by decrypting the further encrypted message (K_{B}) using the recovered further masked seed (M_{B}).

The message may consist of or comprise a secret key for use in further secure communications between the terminals. The further secure communications may use the communication network, but may alternatively use another network, e.g. the Internet. The system may be used to bootstrap trusted secure communications between two subscribers without requiring a physical visit between them. An example of such usage is the secure establishment of a web community, where the message comprises a key for accessing the web community via the Internet, and the message is securely distributed to each member of the web community.

The system can be used for sharing a secret message between terminals subscribed on a single authenticating station, but alternatively, the system may also be used between a first terminal subscribed to a first authenticating station, and a second terminal subscribed to a second authenticating station. This requires the additional step of securely forwarding the message from the first authenticating station to the second authenticating station. This has the advantage that the message may be exchanged securely between terminals that authenticate at respective authenticating stations, e.g. a first mobile phone subscribed to a first network operator and a second mobile phone subscribed to a second network operator. A further advantage is that the first or the second terminal or both the terminals may be roaming, i.e. away from their home network and served by a visiting network.

The security of the system has a basis in that only the first terminal and the authenticating station share the masking function F_{A}, and similarly, in that only the second terminal and the authenticating station share the masking function F_{B}.

Since each masking function is only shared between a terminal and the authenticating station, the user of the first terminal may be sure that only the authenticating station can generate the decryption key and recover the message. Similarly, the user of the second terminal may be sure that only the authenticating station can recover the message from the seed and generate the masked seed, ensuring that the message comes from a trusted source.

The components of the system, comprising the first and the second terminal and the authenticating station are each arranged to execute the intended actions in the order given, so as to collaborate for a secure communication of the message. A manual trigger by a user of the first terminal may initiate the actions from the first terminal, but also an automated trigger may do so, e.g. from a software application running on the first terminal.

The message may be in a digital or in an analog format. If the message is in an analog format, it may be converted into a digital format before the encryption. Alternatively, the encryption may be performed on the analog format of the message.

The transmitting may also comprise an identification of the second terminal, e.g. a medium access control (MAC) address, an Internet Protocol (IP) address, a Uniform Resource Identifier (URI) or Locator (URL), a Session Initiation Protocol (SIP) address, a subscriber identifier (IMSI), an equipment identifier (HMI), or a telephone number as an E.164 address.

The transmitting may be performed with known signaling methods or channels, but it may also involve a method or channel dedicated to this purpose.

U.S. Pat. No. 6,373,946B1 discloses a system for distributing enciphering key data in a satellite mobile telecommunication system. The enciphering key data is distributed from a remote node to both terminals, however, thus solving a problem other than that of securely communicating a message between the first and the second terminal.

In an embodiment, the system has the features of claim 2. This provides the advantage that the message may be distributed from the first terminal to both the second and the third terminal. It also saves execution time and power, because the authenticating station does not execute the first steps a second time. Furthermore, an overhead of the protocol between the first terminal and the authenticating station may be saved, because the transmitting may simply comprise a further identification of the third terminal.

Another advantage is the additional convenience for the user operating the first terminal, as lists of terminals may be addressed in one go.

This system may be used in particular for bootstrapping secure communications amongst a plurality of terminals. The system may be used for securely establishing one of the popular World Wide Web or Wireless Access Protocol communities on the Internet.

The system may be further expanded to include at least one further terminal, and as such is not limited to three terminals.

In another embodiment, the system has the features of claim 3. This further increases the ease of use for the end-users operating the terminals. Mobile phone networks. are ubiquitous, such that the message may be exchanged with large numbers of terminals.

Since the masking function and the further masking function are respective authentication functions of the mobile phone network, this system fits in well with the typical mobile phone infrastructure, where a terminal gains access to the network after authentication with the authenticating station. This provides a strong authentication based on a secret key shared between a tamper-proof security module in the terminal and the authenticating station.

As the primitives of the system are already in place in a typical mobile phone network, the system is relatively easy to deploy, alleviating much of the burden of alternative systems.

Although the first terminal may consist of a mobile phone, the first terminal may also comprise further components like further coupled devices, e.g. a PDA or laptop computer.

It typically suffices that the transmitting means are part of a first mobile phone, and that the further receiving means are part of a second mobile phone.

The means for obtaining the random seed and the computing means may advantageously be implemented in a tamper-proof module, for example, a smartcard or a Subscriber Identity Module (SIM).

The first terminal dialing a particular telephone number dedicated for this purpose may trigger execution of the steps in the authenticating station. Alternatively, execution of the method may be triggered by wrapping the message and the address of the second terminal in a dedicated type of content for the ubiquitous Short Message Service (SMS) and sending the content to a particular dedicated destination address. Although messages may be communicated by means of SMS services, these services provide a lower level of security than the security level that may be achieved with a system according to the invention. This is especially the case if the computations are executed in the tamper-proof Secure Identification Module (SIM).

Both subscribers trust the network operator, which acts as a trusted third party. The message may consist of or comprise a public key for use in further secure communications between the terminals. In that case, the system ensures that the public key comes from an authenticated trusted terminal.

The system can be deployed with relatively little cost because only relatively minor changes to the existing mobile phone network are required. For the network operator, it has the advantage of allowing a new service offer to the end-users. Also, the service is relatively simple to deploy through the network.

The system may be combined in a relatively easy way with the billing functionality of the mobile phone network. Payments for using the system may be debited from an end-user account.

The system may also be adapted for use with a roaming terminal, where the system comprises a visitor location register for registering visiting subscribers. After communication between the authenticating station and the visitor location register, for example, carried by the mobile application part in a network with the signaling system number 7 set of standards, the visitor location register may act as a proxy for the authenticating station, having a replica of some data in the authenticating station.

In a particular embodiment of the system, the message may be an SMS message. This offers the advantage that part of the existing infrastructure may be used, e.g. an SMS message editor in the first terminal, an SMS message handling application like an inbox, outbox and menus for their control. It also offers the advantageous combination of a relatively high security level, which approaches the security level of the subscription, with the convenience and popularity of SMS messaging.

In another embodiment, the system has the features of claim 4. A particularly popular type of mobile phone network is based on the GSM or UMTS standards. The A3 authentication function has proven to be secure and cost-effective in practice, while still leaving room for network operators to set parameters for specializing the authentication function for their network.

The above object and features of the system 100 of the present invention will be more apparent from the following description with reference to the drawings.

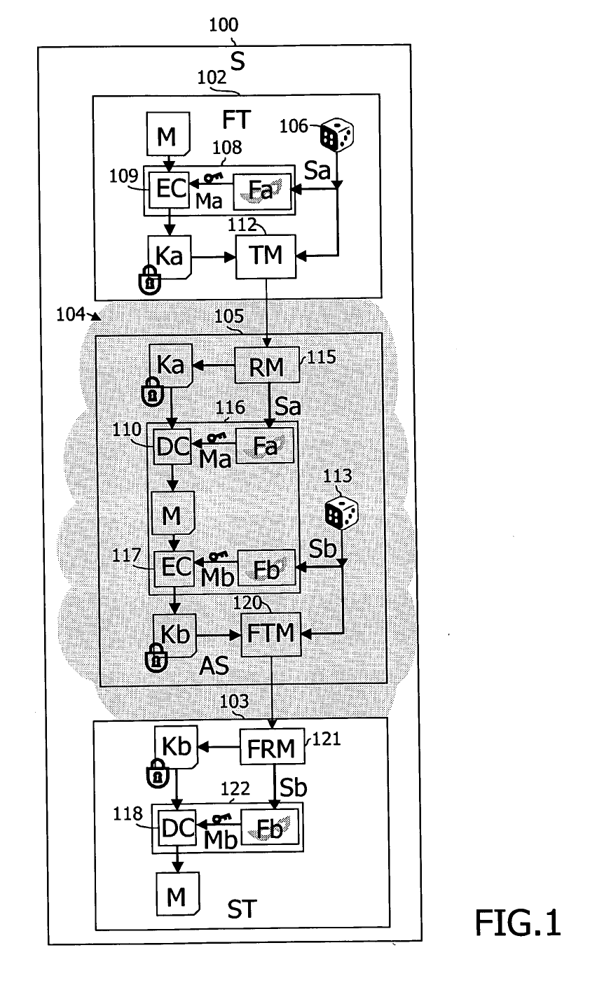

FIG. 1 is a block diagram of a system 100 according to the invention.

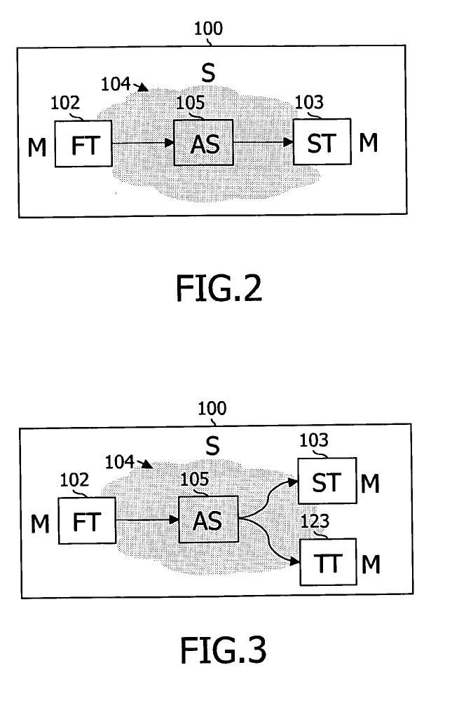

FIG. 2 shows an overview of a system 100 according to the invention.

FIG. 3 shows an overview of a system 100 with a third terminal according to the invention.

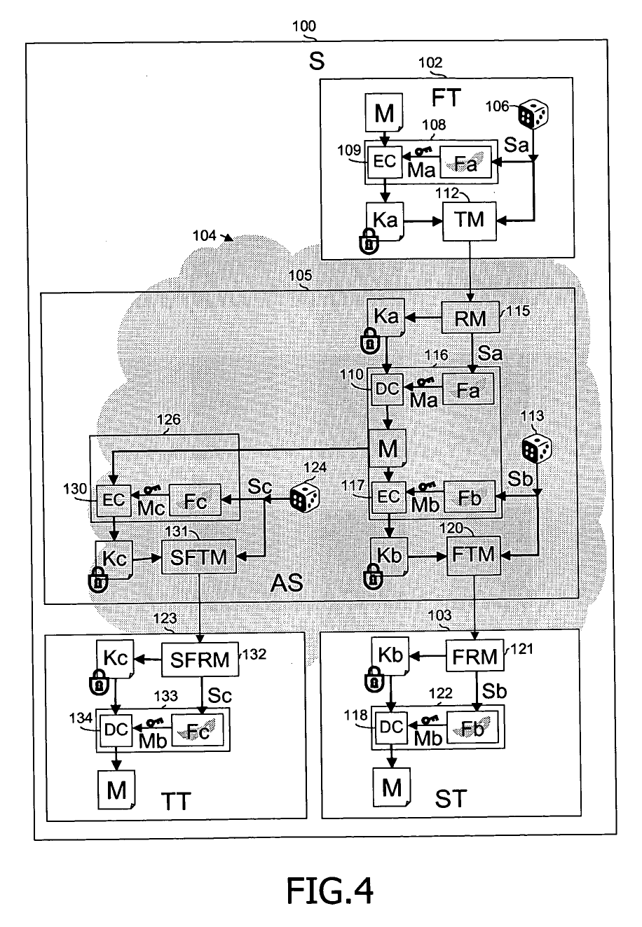

FIG. 4 is a block diagram of a system 100 with a third terminal according to the invention.

In the embodiment of FIG. 2, the system 100 comprises a first terminal 102, a second terminal 103 and a communication network 104 with an authenticating station 105. The first and the second terminal 102, 103 are adapted GSM or UMTS phones operatively coupled by means of a GSM communication network 104 which includes a home location register (HLR) 105. The system 100 is arranged for secure communication of a message M from the first terminal 102 to the second terminal 103.

The embodiment of FIG. 2 is shown in more detail in FIG. 1. The first terminal 102 has means 106 for obtaining a random seed S_{A}. The means 106 may be a random number generator and may be implemented in hardware, or partially or as a whole in software. One example is a linear congruential random number generator. The means 106 may also be used in creating the message M. This is particularly advantageous if the message M comprises a key for use with further communications between the terminals 102, 103, because such a key may be generated with the help of a random number generated by the means 106. This saves a random number generator.

The first terminal 102 has computing means 108 arranged to obtain a masked seed M_{A} by applying a masking function F_{A} to the seed S_{A}. The computing means 108 may be or comprise a general-purpose processor as is commonly used in a computer like a desktop, a laptop, a handheld or a palmtop computer. The computing means 108 may also be or comprise a dedicated processor like an embedded processor in a GSM or UMTS phone, or a smartcard. The computing means 108 may partially or as a whole be tamper-proof, for example, like the ubiquitous Subscriber Identity Module (SIM) used in mobile phones, or a chipcard with an e-purse function. This has the advantage that it is relatively hard to tamper with the computing means 108 so as to manipulate its behavior or peek in its internals to recover e.g. the message M or the masking function M_{A}, such that the effort to crack the computing means typically outweighs the gain in doing so.

The masking function M_{A} has the property that it masks the random seed S_{A} to which it is applied, such that it is relatively hard to recover the random seed S_{A} from the masked random seed M_{A}.

Just like the further masking function F_{B}, the masking function F_{A} may be respective authentication functions of the terminals 102, 103 of a mobile phone network 104. The masking function may be as simple as an exclusive one or with a serial number or a hardware key that differs between terminals.

The respective authentication functions may be the A3 authentication functions of the first and the second terminal 102, 103 if the network 104 is a GSM mobile phone network. Alternatively, the A5, A8 or GEA3 functions may be used. In turn, each of these functions may rely on the KGCORE function. Advantages of these functions include that they allow keys with arbitrary but predetermined lengths. These functions are described, for example, in 3GPP TS 55.216 V6.2.0.

The computing means 108 are further arranged to obtain an encrypted message 109 by encrypting the message M using the masked seed M_{A} as a key for the encryption. The encryption may be based on secret key algorithms, for example, the DES or triple-DES algorithms, or on public key algorithms like ElGamal or Diffie-Helman cryptography.

The first terminal 102 has transmitting means 112 for transmitting the seed S_{A} and the encrypted message K_{A} to the authenticating station 105. The transmitting means 112 may be arranged to transmit through a medium that has a wire or is wireless, with e.g. an RF transmitter and an antenna in the latter case. The transmission may e.g. take place with an SMS or with an MMS. Conveying the encrypted message K_{A} to the authenticating station 105 may involve several links, for example, one wireless link to the base station of the GSM network, followed by wired links to the authenticating station.

The authenticating station 105 serves the purposes of authenticating the messages K_{A} transmitted by the first terminal 102, re-encrypting the message, and forwarding the message to the destination terminal 103. The authenticating station 105 may be a HLR as is common in GSM networks, but it may also be a SIP server, or another server.

The authenticating station 105 has receiving means 115 for receiving the seed S_{A} and the encrypted message K_{A} from the first terminal, for example, a GSM receiver. The authenticating station 105 also has further computing means 116. The further computing means 116 may be e.g. a general-purpose or a dedicated processor. The authenticating station 105 also has a random number generator 113 for generating the further random seed S_{B}. The random number generator 113 may be implemented in the further computing means 116, for example, with a software routine implementing a linear congruential random number generator.

The authenticating station 105 is arranged to recover the further masked seed M_{A} by applying the masking function F_{A} to the seed S_{A}, recovering the message M by decrypting the encrypted message K_{A} using the recovered masked seed M_{A}, obtaining a further masked seed M_{B} by applying a masking function F_{B} to the further seed S_{B}, and obtaining a further encrypted message K_{B} by encrypting the recovered message M using the further masked seed S_{B}. These steps may be implemented largely in software routines executed by a processor comprised by the further computing means 116.

The authenticating station 105 has further transmitting means 120 for transmitting the further seed S_{B} and the further encrypted message K_{B} to the second terminal. Again, in a GSM network, this involves both wired and wireless links, from a HLR to a base station to the second terminal, which may be an adapted mobile phone.

The second terminal 103 has receiving means 121 and further computing means 122.

The receiving means 121 receive the further seed S_{B} and the further encrypted message K_{B}, and the receiving means 121 may be part of e.g. an adapted GSM phone. The adaptation to the mobile phone may be limited to the software embedded or downloaded in the phone, with the advantage that the adaptations are relatively cheap. The further computing means 122 have the purposes of recovering the further masked seed M_{B} by applying the masking function F_{B} to the further seed S_{B}, and of recovering the message M by decrypting the further encrypted message K_{B} using the recovered further masked seed M_{B}. Subsequently, the recovered message M may be stored, forwarded, presented or further processed.

In the embodiment of FIG. 3 and FIG. 4, the system has a third terminal 123. What has been stated about the second terminal 103 also holds for the third terminal 123. The third terminal 123 may well be identical to the second terminal 103. In this embodiment, the authenticating station 105 has still further means 124 for obtaining a still further random seed S_{C}, yet further computing means 126, and still further transmitting means 131 for transmitting the still further random seed S_{C} and the still further encrypted message K_{C} to the third terminal 123. The yet further computing means 126 are arranged to obtain a still further masked seed M_{C} by applying a still further masking function F_{C} to the still further random seed S_{C}, and obtaining a still further encrypted message K_{C} by encrypting 130 the recovered message M using the still further masked seed M_{C}. The third terminal 123 has still further receiving means 132 for receiving the still further random seed S_{C} and the still further encrypted message K_{C}, yet still further computing means 133 for recovering the still further masked seed M_{C} by applying the still further masking function F_{C} to the still further random seed S_{C}, recovering the message M by decrypting 134 the still further encrypted message K_{C} using the still further masked seed M_{C}. Of course many more than two terminals may be part of the system. Moreover, many terminals may be addressed in one go when sending the message M from the first terminal 102 to the authenticating station 105, such that the message M is delivered to each addressed terminal.

The embodiments of the system 100 according to the invention as described above are each arranged to execute the method according to the invention.

Also, the above described embodiments of the first and the second terminal 102, 103, and of the authenticating station 105, may each have a processor programmed with a computer program product according to the invention, enabling each processor to execute its part of the method according to the invention.

It is noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. Use of the indefinite article “a” or “an” preceding an element does not exclude the presence of a plurality of such elements. The invention can be implemented by means of hardware comprising several distinct elements, and by means of a suitably programmed computer. In a system or a device claim that enumerates several means, the same item of hardware may embody several of these means. The mere fact that certain measures are recited in mutually different dependent claims does not indicate that a combination of these measures cannot be used to advantage.

A ‘computer program’ is to be understood to mean any software product stored on a computer-readable medium, such as a floppy disk, downloadable via a network, such as the Internet, or marketable in any other manner.

| 99 | Fig. | Text 99 | Abbr. |
|---|---|---|---|
| 100 | 1 | system | S |
| M | 1 | message | M |
| 102 | 1 | first terminal | FT |
| 103 | 1 | second terminal | ST |
| 104 | 1 | communication network | CN |
| 105 | 1 | authenticating station | AS |
| 106 | 1 | means | M |
| Sa | 1 | random seed | RS |
| 108 | 1 | computing means | CM |
| 109 | 1 | encrypting | |
| Ma | | masked seed | MS |
| 110 | 1 | decrypting | |
| Fa | | masking function | MF |
| Ma | 1 | encrypted message | EM |
| 112 | 1 | transmitting means | TM |
| 113 | 1 | further means | FM |
| Sb | 1 | further random seed | FRS |
| 115 | 1 | receiving means | RM |
| 116 | 1 | further computing means | FCM |
| 117 | 1 | encrypting | |
| Mb | | further masked seed | FMS |
| 118 | 1 | decrypting | |
| Fb | | further masking function | MF |
| Kb | 1 | further encrypted message | FEM |
| 120 | 1 | further transmitting means | FTM |
| 121 | 1 | receiving means | RM |
| 122 | 1 | further computing means | SFCM |
| 123 | 3 | third terminal | TT |
| 124 | 3 | further means | SFM |
| 125 | 3 | further random seed | SFRS |
| 126 | 3 | further computing means | YFCM |
| 127 | 3 | further masked seed | SFMS |
| 128 | 3 | further masking function | SFMF |
| 129 | 3 | further encrypted message | SFEM |
| 130 | 3 | encrypting | E |
| 131 | 3 | further transmitting means | SFTM |
| 132 | 3 | further receiving means | SFRM |
| 133 | 3 | further computing means | YSFCM |
| 134 | 4 | decrypting | D |

1. A system (100) for secure communication of a message (M) from a first terminal (102) to a second terminal (103), the first terminal (102) being operatively coupled to the second terminal (103) by means of a communication network (104) comprising an authenticating station (105), the system comprising:
the first terminal (102), comprising:
means (106) for obtaining a random seed (S_{A}),
computing means (108) for obtaining a masked seed (M_{A}) by applying a masking function (F_{A}) to the seed (S_{A}), and for obtaining an encrypted message (K_{A}) by encrypting the message (M) using the masked seed (M_{A}),
transmitting means (112) for transmitting the seed (S_{A}) and the encrypted message (K_{A}) to the authenticating station;
the authenticating station (105), comprising:
further means (113) for obtaining a further random seed (S_{B}),
receiving means (115) for receiving the seed (S_{A}) and the encrypted message (K_{A});
further computing means (116) for:
a. recovering the masked seed (M_{A}) by applying the masking function (F_{A}) to the seed (S_{A}),
b. recovering the message (M) by decrypting the encrypted message (K_{A}) using the recovered masked seed (M_{A}),
c. obtaining a further masked seed (M_{B}) by applying a masking function (F_{B}) to the further seed (S_{B}), and
d. obtaining a further encrypted message (K_{B}) by encrypting the recovered message (M) using the further masked seed (M_{B}),
further transmitting means (120) for transmitting the further seed (S_{B}) and the further encrypted message (K_{B}) to the second terminal;
the second terminal (103), comprising:
receiving means (121) for receiving the further seed (S_{B}) and the further encrypted message (K_{B});
still further computing means (122) for:
a. recovering the further masked seed (M_{B}) by applying the masking function (F_{B}) to the further seed (S_{B}),
b. recovering the message (M) by decrypting the further encrypted message (K_{B}) using the recovered further masked seed (M_{B}).

2. A system as claimed in claim 1, further comprising a third terminal (123), wherein
the authenticating station (105) further comprises:
still further means (124) for obtaining a further random seed (S_{C}),
yet further computing means (126) for:
a. obtaining a still further masked seed (M_{C}) by applying a still further masking function (F_{C}) to the still further random seed (S_{C}), and
b. obtaining a still further encrypted message (K_{C}) by encrypting (130) the recovered message (M) using the still further masked seed (M_{C}),
still further transmitting means (131) for transmitting the still further random seed (S_{C}) and the still further encrypted message (K_{C}) to the third terminal;
the third terminal (123) comprises:
still further receiving means (132) for receiving the still further random seed (S_{C}) and the still further encrypted message (K_{C});
yet still further computing means (133) for:
a. recovering the still further masked seed (M_{C}) by applying the still further masking function (F_{C}) to the still further random seed (S_{C});
b. recovering the message (M) by decrypting (134) the still further encrypted message (K_{C}) using the still further masked seed (M_{C}).

3. A system as claimed in claim 1, wherein the communication network (104) comprises a mobile phone network, and wherein the masking function (F_{A}) and the further masking function (F_{B}) are respective authentication functions of the mobile phone network.

4. A system as claimed in claim 3, wherein the mobile phone network is a GSM network and wherein the respective authentication functions are the A3 authentication functions of the first (102) and the second terminal (103).

5. A first terminal (102) for use in a system according to claim 1.

6. An authenticating station (105) for use in a system according to claim 1.

7. A second terminal (103) for use in a system according to claim 1.

8. A method of securely communicating a message (M) from a first terminal (102) to a second terminal (103), the first and the second terminal being operatively coupled by means of a communication network (104) comprising an authenticating station (105), the method comprising the steps of:
the first terminal (102):
obtaining a masked seed (M_{A}) by applying a masking function (F_{A}) to a random seed (S_{A});
obtaining an encrypted message (K_{A}) by encrypting the message (M) using the masked seed (M_{A});
transmitting the random seed (S_{A}) and the encrypted message (K_{A}) to the authenticating station;
the authenticating station (105):
receiving the random seed (S_{A}) and the encrypted message (K_{A});
recovering the masked seed (M_{A}) by applying the masking function (F_{A}) to the random seed (S_{A});
recovering the message (M) by decrypting the encrypted message (K_{A}) using the masked seed (M_{A});
obtaining a further masked seed (M_{B}) by applying a further masking function (F_{B}) to a further random seed (S_{B});
obtaining a further encrypted message (K_{B}) by encrypting the message (M) using the further masked seed (M_{B});
transmitting the further random seed (S_{B}) and the further encrypted message (K_{B}) to the second terminal;
the second terminal (103):
receiving the further random seed (S_{B}) and the further encrypted message (K_{B});
recovering the further masked seed (M_{B}) by applying the further masking function (F_{B}) to the further random seed (S_{B});
recovering the message (M) by decrypting the further encrypted message (K_{B}) using the further masked seed (M_{B}).

9. A computer program product for execution on a processor of a first terminal (102), enabling the first terminal to execute its part of the method according to claim 1.

10. A computer program product for execution on a processor of an authenticating station (105), enabling the authenticating station to execute its part of the method according to claim 1.

11. A computer program product for execution on a processor of a second terminal (103), enabling the second terminal to execute its part of the method according to claim 1.
